(19) United States
(12) Patent Application Publication
(10) Pub. No.: US 2015/0078642 A1
(43) Pub. Date: Mar. 19, 2015

(54) METHOD AND SYSTEM FOR NON-INVASIVE QUANTIFICATION OF BIOLOGIAL SAMPLE PHYSIOLOGY USING A SERIES OF IMAGES

(71) Applicant: The General Hospital Corporation, Boston, MA (US)

(72) Inventor: Qianqian Fang, North Reading, MA (US)

(21) Appl. No.: 14/396,007

(22) PCT Filed: Apr. 23, 2013
(86) PCT No.: PCT/US2013/037834

§ 371 Date: Oct. 21, 2014

Related U.S. Application Data
(60) Provisional application No. 61/637,641, filed on Apr. 24, 2012.

(51) Int. Cl. G06T 7/00; G06T 15/00; G06T 7/60

(52) U.S. Cl. CPC G06T 7/0012; G06T 7/60; G06T 15/00; G06T 2207/30016
USPC 382/131

(57) ABSTRACT

Method for providing external response based on changes in physiological status of biological sample determined by co-registration of sample images acquired in near-infrared and visible light, optionally by the user himself with a camera of a cell-phone cooperated with the data-processing unit. The NIR and visible image data are spatially co-registered with respect to spatial reference points associated with positions and orientations of camera to spatially coordinate the NIR and visible light images. Three-dimensional surface representing a sample's shape is determined based on stereo analysis of the first data. The NIR data is mapped onto such surface based on established spatial correlation to generate a topographic image representing the subsurface ROI and conforming to the sample's surface at multiple locations. Spatial distribution of the parameter characterizing a physiological function of the subsurface ROI of the sample is then determined based on the second and third data and the topographical image.

### CROSS-REFERENCE TO RELATED APPLICATIONS

The present application claims benefit of and priority from the U.S. Provisional Patent Application No. 61/637,641 filed on Apr. 24, 2012 and titled “Functional near-infrared brain imaging assisted by a low-cost mobile phone camera.” The disclosure of this provisional patent application is incorporated herein by reference in its entirety.

### TECHNICAL FIELD

The present invention relates to non-invasive characterization of tissue physiology of a biological sample with the use of a multi-wavelength imaging. In particular, the present invention relates to enablement of an end-effector device that is external to the biological sample in response to the input formed on the basis of characterization of a change in a physiological parameter characterizing a sub-surface region of the sample.

### BACKGROUND

Diffuse optical imaging (DOI) is an emerging technique that is being developed for safe and non-invasive characterization of physiological functions of a biological tissue (such as, for example, oxy- and deoxy-hemoglobin concentrations, tissue oxygen saturation, peripheral oxygen saturation, blood flow and hemodynamics). Potential applications of this technique may include the study of human brain functions and the detection of breast cancer.

The DOI involves the illumination of the human body with near-infrared (NIR) light at various wavelengths, and measurement of the absorbed and/or scattered light on the surface of the tissue. Tissue chromophores, including oxy-/deoxy-hemoglobin, water and lipids, have relatively low absorption in the NIR range. As a result, NIR photons can penetrate much deeper into tissue than photons in the visible range. The absorption spectra of these chromophores are different, shown in FIG. 1, making it possible to quantify the concentrations of each chromophore by measuring the light attenuation at multiple wavelengths. With the use of photon transport models and optimization techniques, one can recover a 2D (topographic) image or 3D (tomographic) image of the optically derived physiological parameters of the tissue sample.

The construction and performance of DOI imaging systems vary significantly from application to application. For human brain functional imaging, for example, nearly all related art systems are fiber-optics based. They operate, in principal, by coupling, light emitted from an NIR light source (such as a laser or an LED) into optical fibers through which light it delivered to and used for irradiation of a human head. The back-scattered light from the brain tissue is collected by larger fiber bundles that are in direct contact with the head, and is further guided to photon detectors (such as avalanche photodetectors, APDs, or photomultilying tubes, PMTs). The related art of functional near-infrared spectroscopy technique, or fNIRS, has been focused so far on the determination of the hemodynamics following a stimulus (such as finger tapping, medium nerve stimulus, audio/visual stimulus, or a cognitive task). The images obtained from such system are primarily 2D topographic images of either raw optical signal changes or hemoglobin variations (such as those illustrated in FIG. 2). In most cases, the reconstruction of these images ignores the three-dimensional (3D) shape of the subject head anatomy and assumes a rather simple head model, such as semi-infinite homogeneous medium or two-layered medium. As the geometries of the head and that of the cortex surface are rather complex, such simplification and assumption can cause significant deviation of the estimated functional activation parameters from the actual parameters. While more accurate quantifications of brain hemodynamics by means of 3D diffuse optical tomography (DOT) is becoming possible with the recent developments of multi-modality brain functional imaging with multi-modality systems and atlas-based imaging analysis, the exclusive use of fiber-optics as the optical-tissue interface unnecessarily reduces image resolution capabilities of these systems impossible for hand-held and daily use, and requires high level of clinical expertise to operate and analyze the data.

Quantitative DOT reconstruction requires the knowledge of the 3D shape of the target or sample being imaged. Currently, the shape of the object is either assumed, or acquired with the use of a input modality (such as a laser 3D scanner, a structure-light 3D scanner, or a registered MRI dataset, for example). While the latest stereo techniques developed by the computer vision and graphics communities may possibly facilitate convenient acquisition of 3D object shapes, none of these techniques have been applied for quantitative DOT imaging or combined with NIR imaging for compact and efficient instrumentation design.

There remains a need, therefore, for a system and method enabling the simultaneous acquisition of data representing the 3D shape and the sub-surface physiological characteristics of a biological object using an optical imaging system that is capable of non-invasively detecting light in both the visible and NIR ranges with high resolution. The practical implementation of such method not only simplifies the operational structure of the currently employed DOI/DOT imaging systems but also lead to a hand-held and ultra-portable design of the corresponding system. Moreover, the practical implementation of such method enables an operational interface between the tissue sample and a machine that provides feedback response associated with changes in a physiological parameter of the tissue sample corresponding to the deep tissue layers.

### SUMMARY

Embodiments of the invention provide a method for determining a parameter of a biological sample. Such method includes acquiring, with a camera of an imaging system, (i) first surface-sensitive (SS) data representing a surface of the sample in light having a first wavelength, (ii) second deep-structure-sensitive (DSS) data representing a subsurface region of interest (ROI) of the sample in light having a second wavelength, and (iii) third DSS data representing the subsurface ROI of the sample in light having a third wavelength by illuminating the sample from multiple spatial positions. During such acquisition, first multiple spatial positions associated with the acquired first data and second multiple spatial positions associated with the acquired second and third data are co-registered in at least one of a spatial fashion and a temporal fashion to establish spatial correlation between SS images (that have been formed based on the first data) and DSS images (that have been formed based on at least one of the second and third data). The method also includes determining a surface representing a three-dimensional (3D) shape of the sample based on a multi-view stereo analysis of the first data; and mapping the DSS data onto the surface image based on the established spatial correlation to generate a topographic image representing the subsurface ROI and conforming to a surface of the sample at multiple spatial locations. The method further comprises determining a spatial distribution of the parameter characterizing a physiological function of the subsurface ROI of the sample based on the second and third data and the topographic image. In one embodiment, co-registration between the first and second multiple spatial positions is established based on identification of known features present in SS images that has been formed based on the first data in relation to known features present in DSS image that has been formed based on at least one of the second and third data. The method can additionally include forming at least one of a surface map and a volumetric map of the spatial distribution of the determined parameter. Alternatively or in addition, the method may include a step of generating an output (with a processor of the imaging system and based on training data and a change in spatial distribution of the determined parameter) that enables an end-effector to perform a function associated with the training data and a change in said spatial distribution.

In a specific embodiment, the step of determining a surface based on a stereo analysis includes identifying feature points in the SS images (including one or more of corner points, SIFT points, SURF points, and RIFT points); defining a mapping relationship connecting respectively corresponding feature points of the SS images based on matching of the identified feature points; and defining a 3D point cloud of the feature points based on the mapped feature points and respectively corresponding two-dimensional (2D) positions of said points in a series of the SS images. Such specific embodiment of the method may additionally comprise generating at least one of a surface mesh of the sample and a volumetric mesh of the sample by tessellating the 3D point cloud.

In a related embodiment, the step of determining of a spatial distribution of the parameter includes determining, from the second and third data, at least one of an oxy-hemoglobin concentration in the ROI, a deoxy-hemoglobin concentration in the ROI, a level of oxygen saturation in the ROI, a water concentration, a lipid concentration, a scattering coefficient, peripheral oxygen saturation, and arterial oxygen saturation. based on absorption spectra associated with ROI. Optionally, the step of determining of a spatial distribution of the parameter includes at least one of mapping the parameter onto a surface of the target shape with the use of an NIR spectroscopy and forming a 3D volumetric map of the parameter and with the use of diffuse optical tomography.

Embodiments of the invention further provide a system for characterizing a biological sample. The system contains an optical camera; a programmable processor in data communication with the optical camera; and a tangible, non-transitory computer-readable storage medium having a computer-readable code thereon which. When loaded onto the programmable processor, the computer-readable code causes said processor (i) to receive first surface-sensitive (SS) imaging data, second deep-structure-sensitive (DSS) imaging data, and third DSS imaging data acquired by the optical camera that has been repositionably moved with respect to the sample, wherein the first SS data represents a surface of the sample in light having a first wavelength, second DSS data represents a subsurface region of interest (ROI) of the sample in light having a second wavelength, and third DSS data represents the subsurface ROI of the sample in light having a third wavelength; (ii) to establish spatial correlation between SS images that have been formed based on the first data, and DSS images that have been formed based on at least one of the second and third data; and (iii) to calculate a spatial distribution of an identified parameter characterizing a physiological function of the subsurface ROI of the sample based on (a) a surface representing a three-dimensional (3D) shape of the sample determined with the use of a multi-view stereo analysis of the first data; and (b) a topographic image representing the subsurface ROI that has been created by mapping the at least one of the second and third DSS data onto said surface, wherein the topographic image conforms to a surface of the sample at multiple locations. Alternatively or in addition, the system may include an output device (such as a display device or a printer, for example) configured to form a visually-perceivable representation of at least one of the SS images, DSS images, and the spatial distribution of the identified parameter.

In a related embodiment, where the programmable processor is further configured to read external training data, the system of the invention enables a sample-machine interface (SMI) system, in which the programmable processor is further configured to generate an output representing a target operation to be performed, the output being generated in response to training data associated with the sample and a change of the calculated spatial distribution of the identified parameter characterizing a physiological function of the subsurface ROI of the sample; and an end-effector in operable communication with the programmable processor, the end-effector configured to receive the output from the processor and to perform the target operation. In a specific implementation, the sample may include a portion of human brain; the end-effector may include a moveable device; and the processor may be configured to communicate the output to the end-effector in order to control the end-effector to move.

### BRIEF DESCRIPTION OF THE DRAWINGS

The invention will be more fully understood by referring to the following Detailed Description in conjunction with the Drawings, of which:

FIG. 1 depicts plots of spectral dependence of absorption coefficients of biological tissue associated with various bodily chromophores.

FIG. 2 shows schematically the use of a fiber-optic based system of related art providing two-dimensional maps of signal intensity corresponding to brain imaging.

FIG. 3A is a flow-chart of a method according to an embodiment of the invention.

FIG. 3B is a diagram representing positioning of a camera about a sample to be imaged in accordance with an embodiment of the invention.

FIG. 4 is a diagram representing the acquisition of images of the subject's head according to an embodiment of the invention.

FIG. 5 is a diagram showing the 3D head mesh recovered with the method of the invention along with the restored camera views.

FIG. 6 presents a depiction of a zoom-in view of the head mesh of FIG. 5.

FIG. 7A is an NIR image of the subject's head illuminated by a red (650 nm) laser;

FIG. 7B is an image of the subject's head taken under both white-light and NIR irradiation and used for spatial registration of the source of the NIR light according to an embodiment of the invention.

FIG. 8 illustrates an adult brain atlas mesh and mapping the skin landmarks (10-20 s) and the internal structures on the atlas head surface.

FIGS. 9A, 9B illustrates a result of hypothetical reconstruction of brain activations according to an embodiment of the invention. FIG. 9A: when the subject anatomical MRI scan is available, one can recover the activation regions mapped over the actual subject cortical surface mesh. FIG. 9B: when no subject-specific MRI scan results are is available, the atlas mesh of the human head can be used for such reconstruction.

FIGS. 10A through 10E are diagrams illustrating the application of the method of the invention to determination of absorption characteristics of the brain matter of a mouse phantom.

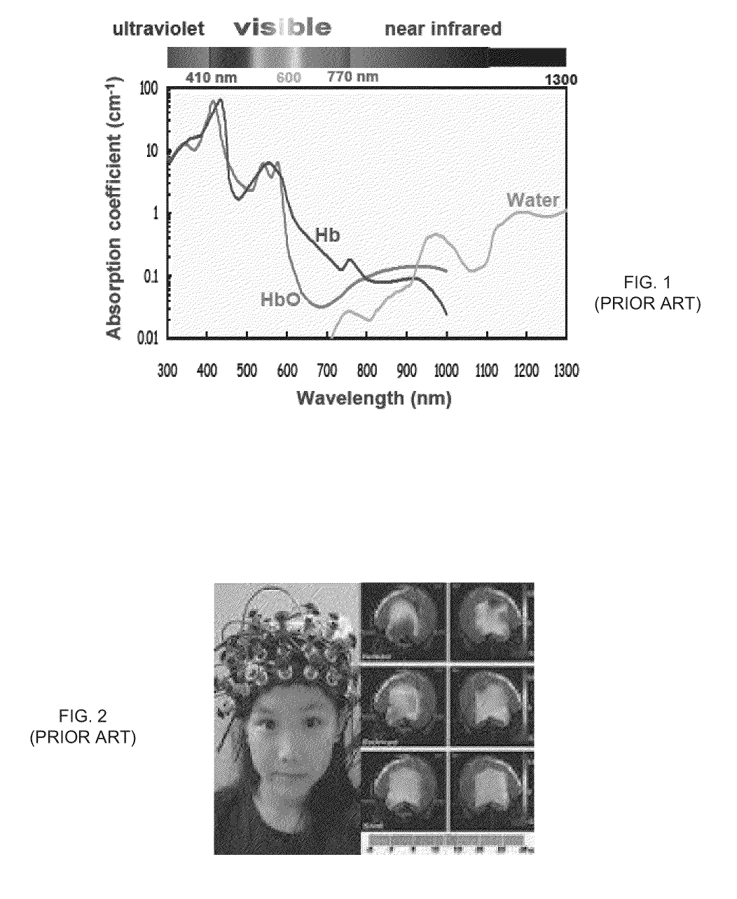

### DETAILED DESCRIPTION

A system and method are described that enable the simultaneous acquisition of imaging data, in the NIR and visible spectral regions, that represent an object tissue layer located at substantial tissue depth and an outside shape of the object, respectively. This is effectuated in contradistinction with prior art, where both types of data are acquired from operationally uncoordinated separate instruments. The so-acquired NIR and visible-light sets of imaging data are then correlated to associate the anatomy of the target deep-tissue layer with visible landmarks defined by the shape of the object to produce an anatomically accurate estimation of the subsurface region-of-interest (for example, the cortical surface showing the signs of brain activation) and to develop a spatial map of a physiological parameter or a parameter characterizing the target deep-tissue region-of-interest (such as, for example, a hemoglobin map and tomographical map of the brain area) with only minimum hardware involve and through a greatly simplified workflow of data acquisition and image reconstruction.

Embodiments of the invention enable the use of a single optical camera based imaging system to precisely measure the shape of the object in real time and to accomplish a complex DOI task without the operational bias (caused by reliance on assumptions about the shape of the object) and the need for complex and expensive multi-modality imaging systems. According to an embodiment of the invention, a camera-centered measurement scheme utilizes a low-cost camera (such as that found in a mobile phone, a tablet, a Google Glass, or a webcam), thereby enabling the quantitative functional imaging system that is driven by a mobile-phone-related equipment and, therefore, not requiring a clinical setting to complete.

### Example of an Embodiment

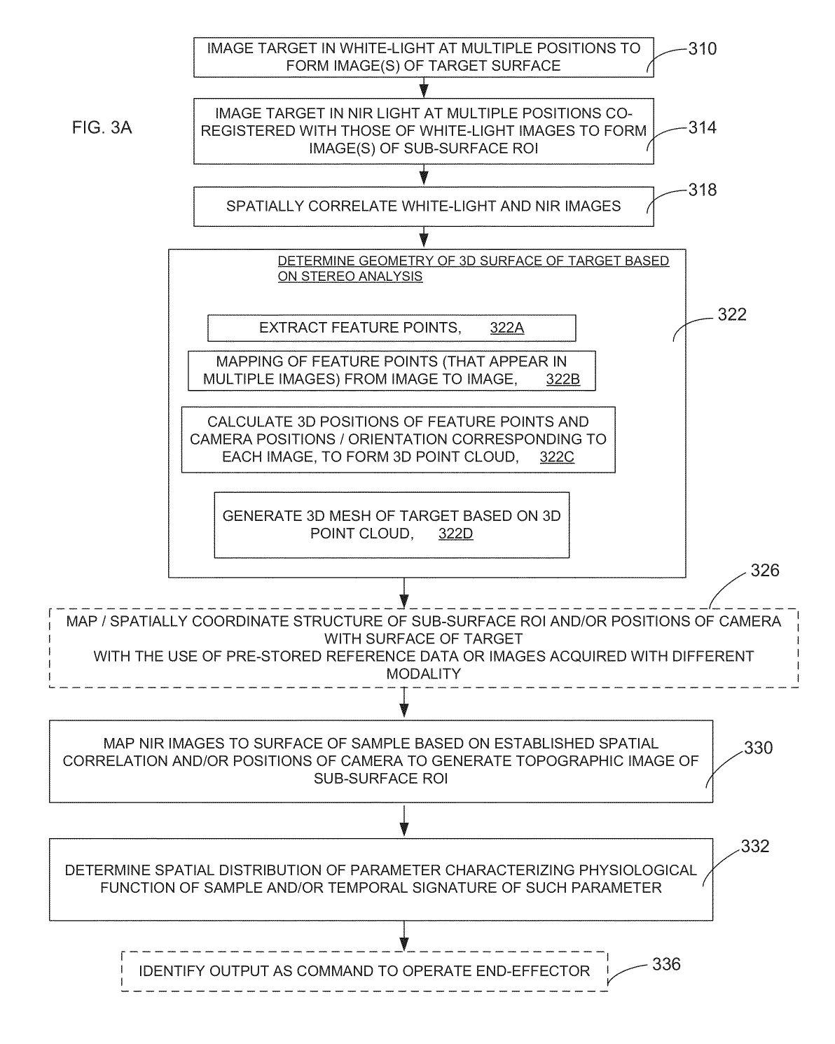

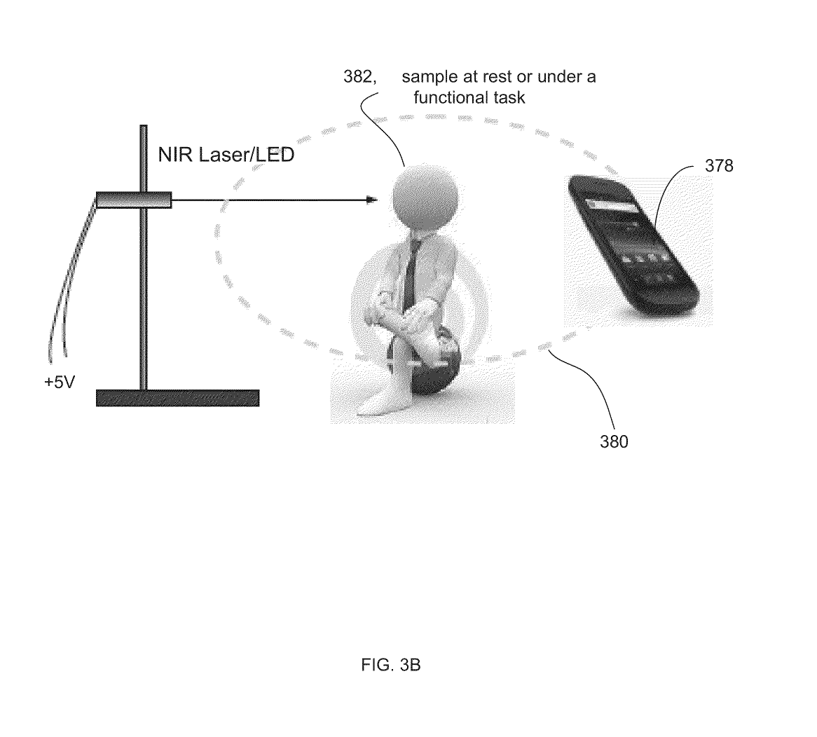

FIG. 3A illustrates an embodiment of a method of the invention, according to which a low-cost biological sample-machine-interface (SMI, which may be a brain-machine-interface or BMI when the sample under test is a human brain) is used to characterize a sample's biological activity and, based on such characterization, facilitate rapid operation of an end-effector device in accord with information represented by training data.

According to the embodiment of FIG. 3A, at step 310 a target (such as a human head or a portion of body) is irradiated with a broad-band light (for example, white-light) such as to illuminate the surface feature(s) of the sample and to show its texture, and images at multiple (for example, at least two) views are taken with an optical camera. Such illumination and surface-sensitive (SS) image acquisition is carried out at at least one wavelength at which the exterior (skin) layer of the sample is reflective, and is taken at various, but at least two, directions/angles with respect to the sample or illumination direction. Sequentially with taking an image of the sample at such first wavelength (or, alternatively, in a separate measurement following such first multi-view visible light image data acquisition), the sample is irradiated with light at at least two different wavelengths at which the radiation penetrates through the skin layer of the sample and penetrates into the subsurface area. (An example of such light is long-wavelength red or near infrared, NIR, light for the human tissue). Images at the at least two such deep-structure-sensitive (DSS) wavelengths are taken at step 314. The DSS images represent a subsurface region of interest (ROI) of the sample, such as, for example, the cortical layer in the brain where the brain activation areas are located or a palpable region inside a human breast where malignant tumor may present. It is appreciated, of course, that optical images can be acquired under other, spectrally-different lighting conditions. In one implementation, a broad-band light source can be used in conjunction with different optical filters used to switch the spectral distribution of the light output from the light source that is directed to the sample. In a related implementation, a lens of the camera can be partially covered with an appropriate optical filter (for example, an optical thin-film based coating) to enable a simultaneous image data acquisition at a visible wavelength and at at least two NIR wavelengths.

Generally, and in reference to FIG. 3B, positions of the camera 378 from which the images of the sample are taken are defined around the sample 382 (and shown, for simplicity, as a set of locations connected by a spatial curve 380). Positions of the imaging camera corresponding to SS-measurements (that produce images and/or streams of video-frames or videos), and the DSS-measurements are correlated according to a known relationship (spatially and/or temporally), as specified by the user. For example, for a given subset of SS images the DSS images are acquired from the same locations and in the same orientation of the camera. In such a case, the co-registration of visible and NIR images in a 3D space is simplified. In another example, for each of the SS images taken from a pre-determined point in space, the corresponding DSS image is taken from a point that is shifted with respect to the pre-determined point in space by, for example, 30 degrees with respect to azimuth and 15 degrees with respect to elevation. Any of the SS images (taken at a first wavelength) and DSS images (taken at second and third wavelengths) can be taken with a single camera that is repositionable with respect to a reference point or with multiple (optionally repositionable) cameras located around the sample. In one implementation, form at least one of the camera positions, sequences of the SS and/or DSS images can be taken as a function of time.

Referring again to FIG. 3A and following the image-acquisition steps, the spatial correlation is established between the SS images and the DSS images, at step 318, based on co-registration of the positions of the camera during the SS- and DSS-image acquisition.

The image data acquired at any wavelength are further processed with the use of a stereo shape-reconstruction algorithm, at step 322, to determine geometry of a surface of the sample and/or to determine a 3D shape of the sample. The stereo algorithm may include at least one of a binocular stereo, a multi-view stereo (MVS), and a photometric stereo algorithms. The stereo algorithm can be applied to the SS data first, prior to the acquisition of the DSS data. Alternatively, both the SS and DSS data may be acquired and store on a tangible computer-readable storage medium first, and then the MVS algorithms is applied to the SS data and to the DSS data independently.

If a multi-view-stereo (MVS) algorithm is used, it may include a feature point extraction algorithm used in the art for scale-invariant object recognition to exact feature points (such as, for example, corner points, scale-invariant feature transform SIFT points, rotation-invariant feature transform or RIFT points, speeded-up robust feature or SURF points), at step 322A. At step 322B, based on matching of the feature points extracted from each of the acquired images and identification of the feature points that are present in multiple images, a mapping between the indices of the feature points from one image to another is created using a RANSAC (random sample consensus) process. This is followed by the estimation of the camera positions/orientations by iteratively minimizing the reprojection errors for all of the matched feature points. This estimation also yields a 3D point cloud for a subset of the feature points on the object surface at step 322C. Further, the 3D point cloud of the feature points corresponding to the surface (skin layer) of the sample is tessellated at step 322C to generate a 3D mesh of the sample (such as a human head surface an/or volume). In one embodiment the tessellation includes triangulation or tetrahedralization operations, resulting in building a triangular surface or a tetrahedral mesh with the point cloud.

Once the surface of the sample is reconstructed, the known features of the surface of the sample (for example, surface landmarks such as the “EEG 10-20 points”) and a registration algorithm (rigid body, affine, or non-rigid transformation algorithm) are optionally used to create the sample's internal structure(s) at step 326. Here:
a) If the sample has previously been subjected to a 3D MRI/CT scan, the newly calculated 3D surface of the sample can be spatially co-registered with the MRI/CT-scanned surface by minimizing the distances between the surface features/landmarks in the two datasets. In case of the human head for example, such co-registration provides orientation of various interior sub-structures (such as the skull, cerebral-spinal fluid (CSF), brain gray matter and white matter) in relation to the skin surface of the head.
b) If the sample has not been previously exposed to a 3D scan, then the atlas (or reference data) can be used, representing the anatomy of the sample averaged over a statistically significant group of subjects, to perform the required co-registration. In this case (considering the human head as a sample), the atlas brain structures, especially the cortex surface, will be mapped to the head surface of the subject.

With the above estimated camera positions/orientations, the irradiance values of DSS NIR images are then spatially co-registered and/or mapped, at step 330, to the surface of the sample by a forward projection (a reverse ray-tracing, for example). (In a special case when the camera is in contact with the surface of the sample, the projection is not required). As a result, the method of the invention the following data is obtained: data representing a 3D shape of the sample (for example, the subject's head), data representing the NIR light source positions, and data representing the light distributions over the surface of the sample from one or multiple angles, at a series of time points.

The DSS (NIR) image data, carrying the information about subsurface ROI (and, if these data are acquired as a function of time, changes in such ROI with time), is now mapped to the surface of the anatomically-correct 3D shape domain that has been estimated with the stereo algorithm. As a result, at step 332, a topographic image on the sample surface representing the physiological status of an ROI (expressed in values of irradiance of the NIR light received at the detector of the imaging camera) is produced. An estimate of a functional parameter characterizing the physiological properties of the subsurface ROI is carried out using one of the model-based image reconstruction techniques (such as the near-infrared spectroscopy, NIRS, and/or diffuse optical tomography, DOT) to obtain a 3D volumetric distribution of the functional parameter underneath the surface of the sample.

By analyzing the spectral variations of the DSS data at at least two NIR wavelength) at a given surface location, the ROI-characterizing physiological parameters (such as, for example, oxy-/deoxy-hemoglobin concentration, oxygen saturation, peripheral oxygen saturation (SpO2) and/or arterial oxygen saturation (SaO2) inside blood vessels) are determined at step 332 as a function of spatial location at the ROI, based on the absorption spectra of different chromophores. In NIRS, the above estimation process is typically a parameter optimization by matching the DSS data with the predicted measurement based on a photon transport model. The NIRS-based analysis may use simplified analytical models, such as semi-infinite, two-layered medium, or numerical models such as Monte Carlo simulation, finite element models etc. The DOT-based analysis typically requires a forward model with the previously defined target shape. In case of the NIRS analysis, the results of the estimated spatial distribution of functional/physiological parameter(s) can be reported to the user with respect to a selected region of interest, or mapped onto the surface confirming to the 3D shape of the sample. In case of the DOT analysis, the 3D volumetric maps of the functional parameters can be formed.

Following the reconstruction of the functional parameter(s) of the subsurface ROI, represented either as a surface map or a volumetric map in co-registration with the surface of the sample, such maps are analyzed (optionally, as a function of time) to determine the changes in the ROI-related functional parameter(s) (optionally, as a function of time) to generate an output controlling an end-effector device, at step 336. Specifically, the ROI-describing readings can be used to control an external machine (including but not limited to a mouse, a keyboard, a program, a computer, a wheelchair, a camera, a robotic arm, a voice synthesizer). Alternatively or in addition, the target shapes, surface/volumetric functional maps, and/or ROI functional parameters and their distributions can be transmitted to a different site or device for recording, documentation, diagnosis and/or personal health monitoring and social interactions with auxiliary participants.

As mentioned above, the DSS images of the sample can be taken not contemporaneously by sequentially to the acquisition of the SS images in visible (or white) light. If such specific case of the “sequential image acquisition” is employed, then, following the preceding step of co-registration, the irradiation of the sample with NIR light is actuated, the white-light illumination is ceased (by a filter or shutting off the light), the camera is positioned towards the region of interest (ROI) of the sample and additional images in the NIR are taken. (In a specific example of brain activation detection, a stream of images or video-frames is preferred, as the brain activity is time-dependent. For example, if the detected brain activity is consequently to control an external end-effector device such as a computer or a neuroprosthetic apparatus, the camera is spatially coordinated with the scalp above the motor cortex; if the detected brain activity is used for speech activation control, the camera is coordinated with the temporal region and the regions related to auditory or speech functionalities.) It is appreciated that if the sample is substantially motionless relative to the camera, the subsequent NIR images are coordinated with a single white-light image. If the sample is moving relative to the camera, for each NIR image it may be required to acquire at least one white-image at the same relative position. The co-registration of so-acquired NIR DSS imaging data is further coordinated with the white-light SS images and the surface of the sample in accordance with steps 326, 330 discussed above.

TABLE 1
Example of optical property values for various head/brain tissue types.
(μₐ: absorption coefficient; μ′ₛ: reduced scattering coefficient)

| Tissue Type | ${µ}_{a} ( \frac{1}{mm} )$ | ${µ}_{s} ( \frac{1}{mm} )$ | Anisotropy (g) | Refractive Index (n) |
|---|---|---|---|---|
| Scalp & skull | 0.019 | 7.8 | 0.89 | 1.37 |
| CSF | 0.004 | 0.009 | 0.89 | 1.37 |
| Gray-matter | 0.02 | 9.0 | 0.89 | 1.37 |
| White-matter | 0.08 | 40.9 | 0.84 | 1.37 |

Example of Use of an Embodiment for Detection of Subsurface Brain Activation and Controlling a Computer with a Brain-Machine Interface Based on the Detected Brain Activation.

To detect subsurface brain activation cannot be accomplished based only on imaging data representing the specular reflection of light from the surface of the subject's head.

In order to get the accurate identification of a cortical region that is activated, a (cortically-constrained) diffuse optical tomography (DOT) reconstruction may be required. According to an embodiment of the invention, such reconstruction is carried out with the following steps:
1) A 3D head/brain model is formed, based on the shape of the head determined previously and co-registered with the internal brain structures (imaged with the NIR light) according to the step discussed in reference to FIG. 3. In forming such a model, reference data representing tissue absorption/scattering values—such as those of Table 1—for each of known anatomical layers are used.
2) Using the known NIR light source position as an input into the model, the light distribution on the surface of and under the surface of the head is found using a forward-propagation algorithm such as, for example, the Monte Carlo (MC) method or the Finite Element Method (FEM).
3) The simulated distribution of light irradiance on the surface of the skin of the head, solved by the forward propagation approach, is compared with the light irradiance distribution(s) determined based on the DSS data (the NIR images of the brain). Based on the difference(s) in light distributions, an update to the assumed properties (including absorption and scattering coefficients) is determined, either on a constrained domain (such as the cortical surface), or throughout the brain region. This may be accomplished by a gradient-based optimization search utilizing, for example, a steepest descent method or a conjugate gradient method.
4) With the updated properties in the head/brain model, the steps 2) and 3) can optionally be run iteratively until a satisfactory match, defined by a pre-determined figure-of-merit (FOM) between the model output and the data experimentally acquired in reflection of the irradiating NIR light from the brain tissues (and representing a hemodynamical parameter) is found.

Accordingly, with the use of a camera (such as a webcam, for example) connected to the computer through the cable or wirelessly, a series of photos/video-frames around the subject's head is taken under the visible light (room ambient light, for example). The area of the head that is associated with the expected brain activations should be sufficiently visible in the camera images. If the ROI is focused around a certain part of the head, for example, the forehead region for decision making, it may suffice to take pictures as a result of only a partial scan around the target region of the head. (Alternatively, if the brain region of interest that is expected to be activated has a wide spatial distribution, then the photos/videos can be taken around the head in a substantially equally-spaced fashion.)

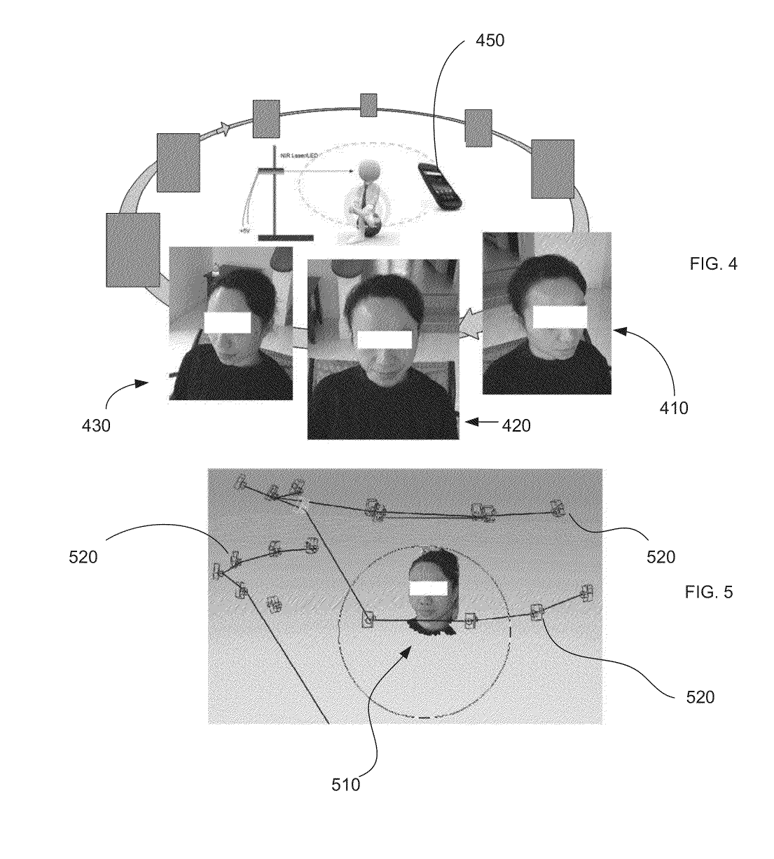

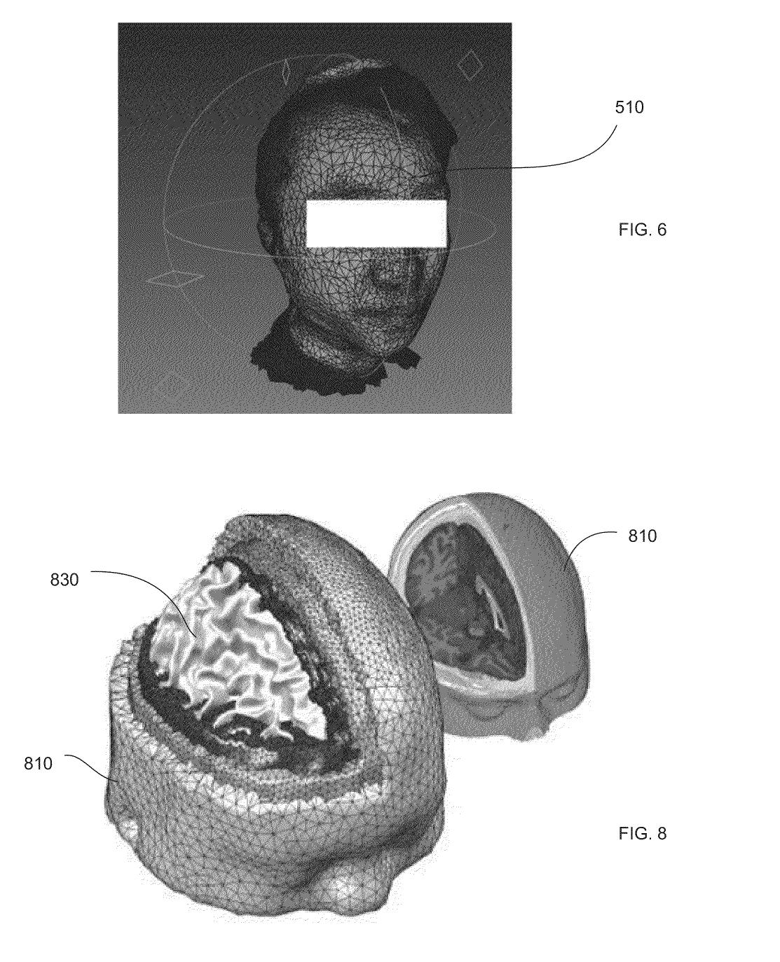

Once the scan in the visible light is completed, the white-light (SS) images are analyzed by the MVS pipeline, according to the method of FIG. 3, to obtain a 3D head geometry and the camera positions/orientations. Thereafter, the relative orientation of the camera and the subject head is fixed (for example, by mounting the camera on a tripod, or putting the camera on a helmet over the head), while the camera is pointed towards the pre-defined area on the head surface, and an additional visible light image is taken. The camera positions/orientations are estimated by combining the additional image to the 3D “scene” with the use of MVS computation. To this end, FIG. 4 provides photo samples 410, 420, 430 taken in white-light taken at various angles around the subject's head with the camera 450. FIG. 5 depicts a 3D head mesh 510 recovered at step 322 of FIG. 3, along with the restored camera positions and orientations 520. FIG. 6 is a zoom-in view of the head mesh 510 of FIG. 5.

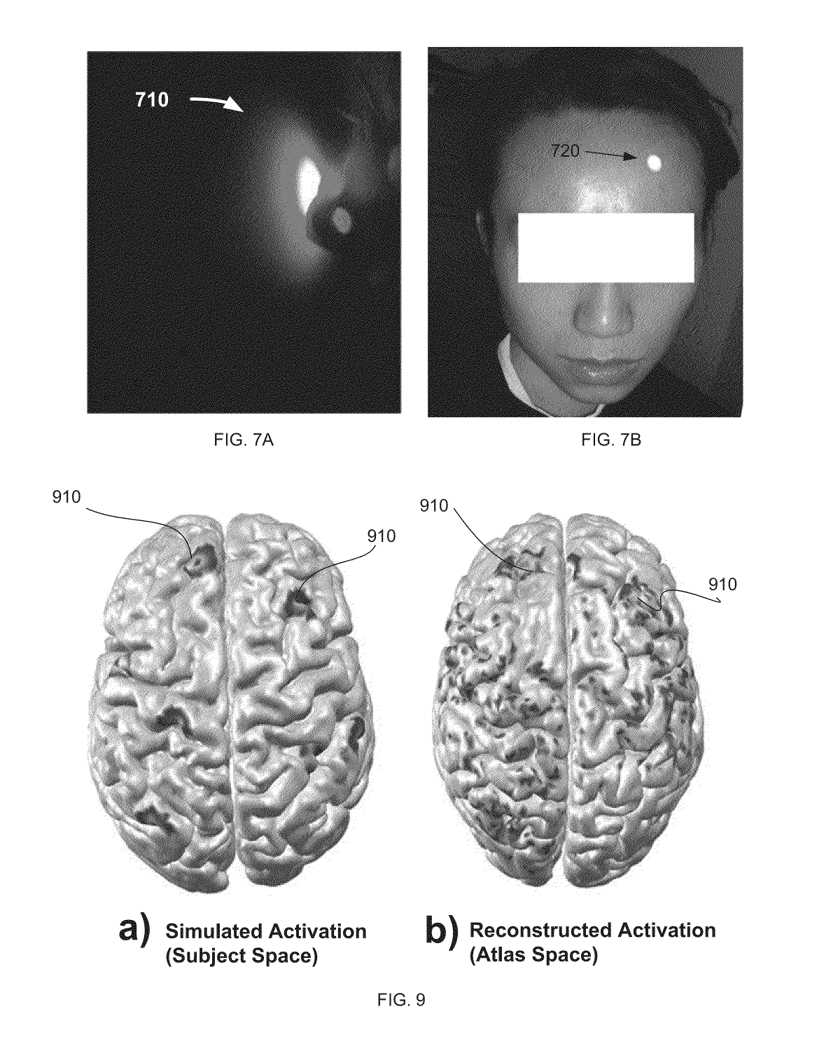

Once camera position/orientations are recovered, the NIR light source is switched on and a visible-light source is turned off or blocked by a visible-light-blocking filter positioned in front of the camera to take NIR images corresponding to the pre-defined area on the head's surface. To this end, FIG. 7A illustrates an NIR image of the subject's head illuminated with a red (650 nm) laser. The area 710 corresponds to the subsurface ROI irradiated with the NIR light. FIG. 7B shows an image acquired with simultaneous irradiation of the subjects head with white-light and NIR light (spot 720).

The images are time dependent at one or multiple locations on the head surface. By analyzing the NW images with NIRS or DOT, the changes in at least one physiological parameter are determined (as discussed above) with respect to, for example, oxy-/deoxy-hemoglobin concentration, oxygen saturation etc, over space or time.

If measurements are carried out at multiple time points, the above discussed analysis is performed for every time point so that the time-dependence of the hemodynamics of the brain is obtained.

In a related implementation, the user can employ an “atlas head” (not the subject-specific head measured with MVS but a statistically averaged head anatomy) to register the NW images; alternatively, one can use a previously acquired results of an MRI scan of the subject to replace the head shape. In such a case, the user would need to take NIR images and register these image with respect to the head anatomy (manually using surface landmarks, for example). To this end, FIG. 8 illustrates the mapping of the skin (surface of the head) landmarks, according to step 326 of FIG. 3 on the “atlas head” surface 810, as well as mapping of the “internal” structures 830 (CSF, skull, gray-matter) to the atlas head surface 810.

An embodiment of the invention enables the identification of the spatial location (centroid) of the brain activation, represented in terms of hemoglobin and/or oxygenation patterns, and/or the temporal signature of the hemodynamic signals. To this end, FIGS. 9A, 9B illustrate reconstructed map presenting spatial distribution of activated areas 910 of the brain (according to step 332 of FIG. 3). FIG. 9A presents such spatial distribution reconstructed based on the available anatomical MRI scan of the subject's head: here, the activation over the actual subject cortical surface mesh is provided. FIG. 9B shows the spatial distribution reconstructed based on the atlas map mesh of FIGS. 8A, 8B.

The spatial and/or temporal signatures of the hemoglobin distribution in the brain, determined based on the SS and DSS measurements according to a method of the invention, can be further correlate with a set of brain states (tabulated, for example, based on earlier experiments in the form of training data) to identify to which brains states such signatures correspond. which in turn is further mapped to a set of pre-specified commands or outputs. For example, if it has been agreed upon with the disabled subject who attempts to operate a PC that the subject's moving his tongue leftward should indicate moving of the PC's mouse to the left, then, when the distribution of a chosen hemodynamic parameter across the subject's brain tissue is measured (with an embodiment of the invention) to correspond to a pre-determined distribution that has been confirmed to correspond to the subject's moving his tongue leftward, the processor-governed system of the invention can generate an output or command to the computer to move the mouse position leftward. Another example of mapping the subject's activity to the operation of an end-effector is tapping the teeth to issue a click/double-click command. If the image sensitivity and resolution are sufficient, one may be able type in words by think aloud a series of letters or words. A similar approach can be used to implement, for example, a control of a wheelchair by a disabled person sitting in the wheelchair.

Alternatively, one can use a 3D tracking device, such as an optical tracker or electromagnetic tracker, or phone accelerometer, to track the position/orientation of the camera. In such case, one may not required the use of surface-based features to recover the relative positions between the acquisition of the SS data in white light and DSS data in NIR light. The tracking device readings would provide such mapping information.

The proposed methodology is data driven. In one embodiment, it uses the image-based calibration (stereo-analysis) process to automatically restore the camera positions/orientations for the white-light and NIR images, avoiding the difficult steps of measuring positions/orientations in the office/home environment. Using the subject specific head mesh and high-density measurements of the NIR light from a camera, we can accurately identify the 3D position, cortical spread, and temporal variations of the brain activations under the scalp. The method of the embodiment enables the user to obtain anatomically accurate functional mapping of the brain to drive refined cognitive recognition and more complex tasks. Compared to the conventional (optical fibers in close proximity to or direct contact with the head) probe approach for topographic mapping of brain activations, the proposed method is more anatomically accurate because it considers the actual subject head shapes and the internal structures and optical properties. In comparison, the traditional method only assumes the head is a homogenous or two-layered semi-infinite slab, thereby causing significant errors when analyzing complex and subtle brain activation distributions.

An additional example of practical use of an embodiment of the invention includes breast screening and cancer detection with the use of a camera of the cellular phone. Early detection of breast cancer is critical for reducing mortality rates caused by this disease. Broad awareness of breast cancer will also greatly improve early detection. A cell phone based NIR imager that can safely, non-invasively scan a breast is expected to simultaneously serve both goals. In response to the feeling of pain or recognition of a palpable mass in the breast, a woman can use a cell phone, operably juxtaposed with the specifically-preprogrammed processor, to examine the nature of the palpable mass by taking the NM images of her breast. A series of photos of the breast in visible light will be taken first. The skin landmarks are extracted, according to the algorithm of FIG. 3, and matched among these images, to form a 3D shape of the breast. The user will then turn on an NIR LED/laser attachment to the cellular phone and illuminate her breast to take additional NIR images with the cell-phone's camera at a set of predefined locations/angles, so that the mapping between the cameras and the breast is known, or so that for every NIR image there is a visible light image taken. By mapping the NIR images to the 3D surface of the breast (according to step 330), and performing DOT or NIRS analysis as discussed above, the user can recover the total hemoglobin concentration (HbT) and oxygen saturation (SO2) maps of the tissue within the breast. Based on published studies, malignant cancer tends to have high HbT and low/heterogeneous SO2; cysts has low HbT and SO2 values; solid benign lesions are similar to the healthy fibroglandular tissue. Using these readings, one can arrive at a determination of whether the observed lump or mass is worrisome, and transmit the readings to the physician to enable remote diagnosis.

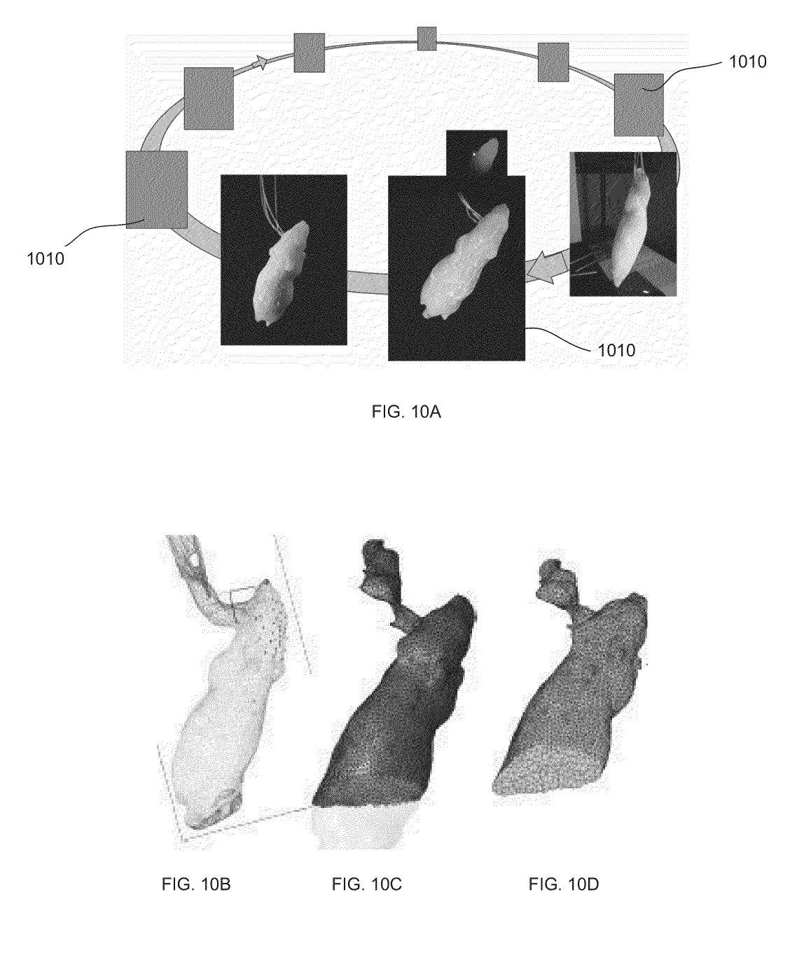

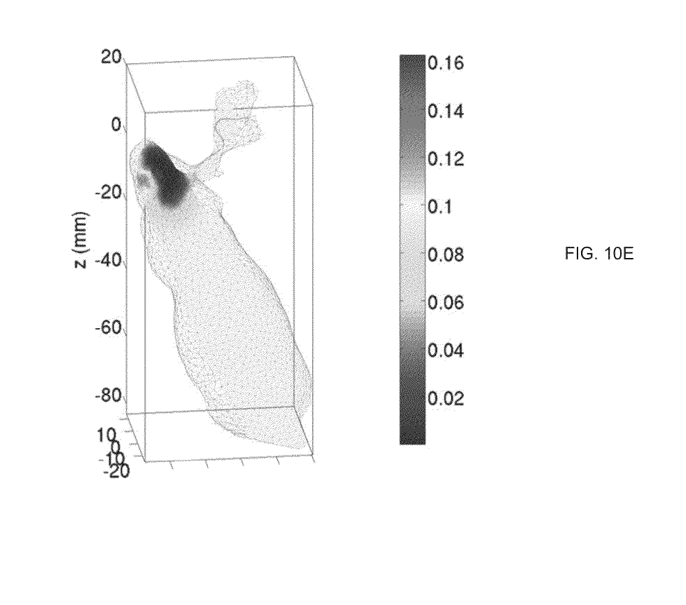

In another example, discussed below in reference to FIGS. 10A through 10E, the embodiment of the invention was employed in quantitative ultra-portable DOT, as a result of which images of a life-size mouse phantom (acquired with an Android smart-phone camera under both white-light and near-infrared illuminations) were successfully stitched together to reconstruct the 3D shape of the phantom (with the use of a finite-element reconstruction algorithm). This implementation demonstrates the operability of the invention for the purposes of drug discovery.

A mouse-shaped phantom was imaged using a smart-phone camera and a low-cost laser module. The phantom was made of resin with a reduced scattering coefficient μₛ′=10/cm and an absorption coefficient μₐ=0.1/cm. Two 3 mm-diameter spherical voids were embedded in the head region of the phantom. The voids were connected by thin tubes, permitting injection of liquid of different optical contrasts. The phantom was suspended in free space by fixing the distal ends of the tubes connected to the voids. A 690 nm laser with an emitting power of 30 mW was used to illuminate the phantom at a series of positions around the phantom. The laser was powered by a 5V DC output from a USB cable connected to a laptop. The cell phone used in this study was a Samsung Nexus S with a 5-megapixel autofocus camera. For the acquisition of the white-light images (step 310 of FIG. 3A), the cell phone was attached to a cell phone mount and moved around the phantom at various azimuth and zenith angles (in accordance to the general scheme of FIG. 3B). The mouse phantom was illuminated by two fluorescent bulbs from opposite directions. For each of about twenty positions 1010 of the camera around the phantom (at roughly equal angular separation at zenith angle θ≈60°, similarly for θ≈45°), a corresponding 2560×1920 pixels photo of the phantom was taken by using the built-in Android Camera App and saved in the JPEG format. To facilitate the photo stitching algorithm, the surface of the mouse was painted with random patterns using a water soluble paint. For taking the images under the NIR illumination (step 314 of FIG. 3A), the cell phone was positioned to face the mouse phantom and perpendicularly to the laser beam. Because the red-channel images can become saturated by the 690 nm laser, the blue-channel image was used instead.

At a first step of the data processing (steps 318-322 of FIG. 3A), an accurate 3D tetrahedral mesh 1020 (see FIG. 10B) of the phantom was created by stitching all white-light images together with the use of a freeware, Autodesk 123D™ Catch. In this software, we select all white-light photos taken at various angles, including the ones shot at the same position as the NIR photo, and submit the images to a cloud-computing server run by Autodesk for processing. The software returns a reconstructed 3D surface mesh that best fits all the photos. It also computes the angle and orientation of the camera for each photo taken. Next, a tetrahedral mesh was created from the recovered surface model. An open-source 3D mesh generation toolbox, iso2mesh, was employed to re-mesh the surface to remove self-intersecting elements. The surface mesh was consequently repaired (FIG. 10C) by filling the enclosed space with tetrahedral elements. The tetrahedral mesh is shown in FIG. 10D. In the second step of the data processing, the optical intensity measurements from the NIR images was extracted and the surface landmarks for the sources and detectors were defined using the 123D software. These landmarks are associated with the 3D model and readily registered with each camera view. One of the white-light images was replaced by the NIR image shot at the same position. The RGB value at each landmark were defined on the surface by averaging the pixels within a 9-by-9 patch centered at the optodes. The phantom surface was assumed to be Lambertian; and the light intensity in direction normal to the surface was calculated using the NIR pixel readings divided by the cosine of the angle between the camera view and surface norms. For multiple NW images such process was repeated. (Because the camera orientation is automatically computed, one does not need to record the exact location and angle of the camera when taking the photos.) In the final step, the prepared 3D meshes and NIR measurements were used to drive a nonlinear image reconstruction and recover the 3D absorption map of the phantom (step 332 of FIG. 3A) with the use of a finite-element (FE) modeling package, Redbird, to perform the forward simulation and Gauss-Newton image reconstruction. A slice 1050 of the tomographic reconstruction of the mouse phantom overlapped with the determined distribution 1060 of the absorption coefficient across the head and body of the phantom is presented in FIG. 10E.

At least some elements of a device of the invention can be controlled, in operation with a processor governed by instructions stored in a memory. The memory may be random access memory (RAM), read-only memory (ROM), flash memory or any other memory, or combination thereof, suitable for storing control software or other instructions and data. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

While the invention is described through the above-described exemplary embodiments, it will be understood by those of ordinary skill in the art that modifications to, and variations of, the illustrated embodiments may be made without departing from the disclosed inventive concepts. Furthermore, disclosed aspects, or portions of these aspects, may be combined in ways not listed above. Accordingly, the invention should not be viewed as being limited to the disclosed embodiment(s).

What is claimed is:

1. A method for determining a parameter of a biological sample, the method comprising:
acquiring, with a camera of an imaging system,
first surface-sensitive (SS) data representing a surface of the sample in light having a first wavelength,
second deep-structure-sensitive (DSS) data representing a subsurface region of interest (ROI) of the sample in light having a second wavelength, and
third DSS data representing the subsurface ROI of the sample in light having a third wavelength by illuminating the sample from multiple spatial positions,
wherein first multiple spatial positions associated with the acquired first data and second multiple spatial positions associated with the acquired second and third data are co-registered in at least one of a spatial fashion and a temporal fashion to establish spatial correlation between
(i) SS images that have been formed based on the first data, and
(ii) DSS images that have been formed based on at least one of the second and third data;
determining a surface geometry representing a three-dimensional (3D) shape of the sample based on a stereo analysis of the first data;
mapping DSS data onto the surface image based on established spatial correlation to generate a topographic image, said topographic image representing the subsurface ROI and conforming to a surface of the sample at multiple spatial locations;
determining a spatial distribution of a parameter characterizing a physiological function of the subsurface ROI of the sample based on the second and third data and the topographic image.

2. A method according to claim 1, wherein a co-registration between the first and second multiple spatial positions is established based on identification of known features present in SS images, which have been formed based on the first data in relation to known features present in DSS images, which have been formed based on at least one of the second and third data.

3. A method according to claim 1, further comprising forming at least one of a surface map and a volumetric map of the spatial distribution of said parameter.

4. A method according to claim 1, wherein the determining a surface geometry based on a stereo analysis includes:
identifying feature points in the SS images including one or more of corner points, SIFT points, SURF points, and RIFT points;
defining a mapping relationship connecting respectively corresponding feature points of the SS images based on a parameter estimation algorithm; and
defining a 3D point cloud of the feature points based on the mapped feature points and respectively corresponding two-dimensional (2D) image coordinates of said points in a series of the SS images.

5. A method according to claim 4, further comprising generating at least one of a surface mesh of the sample and a volumetric mesh of the sample by tessellating the 3D point cloud.

6. A method according to claim 1, wherein the determining a spatial distribution of the parameter includes:
determining, from the second and third data, at least one of an oxy-hemoglobin concentration in the ROI, a deoxy-hemoglobin concentration in the ROI, a level of oxygen saturation in the ROI, a water concentration, a lipid concentration, a melanin concentration, a scattering coefficient, peripheral oxygen saturation, and arterial oxygen saturation based on absorption spectra associated with ROI.

7. A method according to claim 6, wherein the determining a spatial distribution of the parameter includes at least one of (a) mapping the parameter onto a surface of the target shape with the use of an NIR spectroscopy and (b) forming a 3D volumetric map of the parameter and with the use of diffuse optical tomography.

8. A method according to claim 1, further comprising
based on training data and a change in spatial distribution of the parameter, generating an output, with a processor of the imaging system, that causes an end-effector to perform a function associated with the training data and a change in said spatial distribution.

9. A system for characterizing a biological sample, comprising:
an optical camera;
a programmable processor in data communication with the optical camera; and
a tangible, non-transitory computer-readable storage medium having a computer-readable code thereon which, when loaded onto the programmable processor, causes said processor
to receive
first surface-sensitive (SS) imaging data,
second deep-structure-sensitive (DSS) imaging data, and
third DSS imaging data
acquired by the optical camera that has been repositionably moved with respect to the sample,
wherein the first SS data represents a surface of the sample in light having a first wavelength, second DSS data represents a subsurface region of interest (ROI) of the sample in light having a second wavelength, and third DSS data represents the subsurface ROI of the sample in light having a third wavelength;
to establish spatial correlation between SS images that have been formed based on the first data, and DSS images that have been formed based on at least one of the second and third data; and
to calculate a spatial distribution of an identified parameter characterizing a physiological function of the subsurface ROI of the sample based on (i) a surface representing a three-dimensional (3D) shape of the sample determined with the use of a multi-view stereo analysis of the first data; and (ii) a topographic image representing the subsurface ROI that has been created by mapping the at least one of the second and third DSS data onto said surface, wherein the topographic image conforms to a surface of the sample at multiple locations.

10. A system according to claim 9, further comprising an output device configured to form a visually-perceivable representation of at least one of the SS images, DSS images, and the spatial distribution of the identified parameter.

11. A sample-machine interface (SMI) system comprising the system according to claim 9,
wherein the programmable processor is further configured to generate an output representing a target operation to be performed, the output being generated in response to training data associated with the sample and a change of the calculated spatial distribution of the identified parameter characterizing a physiological function of the subsurface ROI of the sample;
and
an end-effector in operable communication with the programmable processor, the end-effector configured to receive the output from the processor and to perform the target operation.

12. An SMI system according to claim 11,
wherein the sample includes a portion of human brain;
wherein the end-effector includes a device capable of movement; and
wherein the processor is configured to communicate the output to the end-effector in order to control the end-effector to move.
